(19) United States
(12) Patent Application Publication
(10) Pub. No.: US 2012/0290988 A1
(43) Pub. Date: Nov. 15, 2012

(54) Multifaceted Visualization for Topic Exploration

(75) Inventors: Jimeng Sun, White Plains, NY (US); David H. Gotz, Purdys, NY (US); Nan Cao, Xi'An City (CN)

(73) Assignee: INTERNATIONAL BUSINESS MACHINES CORPORATION, Armonk, NY (US)

(21) Appl. No.: 13/106,207

(22) Filed: May 12, 2011

(51) Int. Cl. G06F 3/048

(52) U.S. Cl. 715/853

(57) ABSTRACT

A multifaceted visualization technique is provided for visually exploring topics in multi-relational data. A data set is visualized by obtaining the data set comprising a plurality of entities, facets and relations, wherein the entities are instances of a particular concept, the facets are classes of entities and the relations are connections between pairs of the entities; obtaining a selection of one of the facets as a topic facet, wherein entities in the topic facet are topic entities, wherein facets in the plurality of facets other than the topic facet are keyword facets; generating a visualization comprising the topic entities rendered as nodes arranged within a central region; and generating one or more surrounding shapes around the central region, wherein each of the surrounding shapes corresponds to one of the keyword facets, wherein entities within the corresponding keyword facet of a given one of the surrounding shapes are rendered as keyword entities.

### FIELD OF THE INVENTION

The present invention relates generally to the electrical, electronic and computer arts, and, more particularly, to multi-faceted visualization techniques.

### BACKGROUND OF THE INVENTION

Large collections of text documents have become ubiquitous in the digital age. In areas ranging from scholarly reviews of digital libraries to legal analyses of large email databases during a trial, people are increasingly faced with the daunting task of needing to understand the contents of large collections of documents with which they may be unfamiliar.

In recent years, a number of visualization techniques have been developed to assist in this challenge. Topic visualization in particular has received significant attention with several systems designed to extract and render clusters of related documents. A commonly followed approach is to use some variation of spatially arranged clusters, rendered, for example, as a density map or an elevation map. The spatial arrangement of these maps is used to represent the relationship between clusters according to some metric, while labels or tag-clouds can be added to convey some aspect of information associated with each cluster.

While effective at showing an overview of a document collection, the conventional approach is limited in its ability to show multiple dimensions of information about the document clusters simultaneously. In addition, these techniques often make it difficult (if not impossible) to visually identify relationships between individual documents, or how a document fits within a given cluster. Unfortunately, many real-world use cases require this sort of multi-relational, multi-scale analysis.

Documents in rich text corpora often contain multiple facets of information. For example, an article from a medical document collection might consist of multifaceted information about symptoms, treatments, causes, diagnoses, prognoses, and preventions. Thus, documents in the collection may have different relations across each of these various facets. Topic exploration for such multi-relational corpora is a challenging visual analytic task. For the exemplary collection of articles about various diseases, it may not be enough for an analyst to see which diseases fall into a given cluster. A detailed analysis may require that the visualization convey why two diseases may fall into the same cluster (e.g., shared symptoms or treatments) or what overlap may exist between two different yet nearby clusters.

A need therefore exists for a multifaceted visualization technique for visually exploring topics in multi-relational data. A further need exists for a multifaceted visualization technique that simultaneously visualizes the topic distribution of the underlying entities from one facet together with keyword distributions that convey the semantic definition of each cluster along a secondary facet.

### SUMMARY OF THE INVENTION

Generally, a multifaceted visualization technique is provided for visually exploring topics in multi-relational data. According to one aspect of the invention, the disclosed multifaceted visualization technique simultaneously visualizes the topic distribution of the underlying entities from one selected facet, together with keyword distributions that convey the semantic definition of each cluster along a secondary facet.

A data set is visualized by obtaining the data set comprising a plurality of entities, facets and relations, wherein the entities are instances of a particular concept, the facets are classes of entities and the relations are connections between pairs of the entities; obtaining a selection of one of the facets as a topic facet, wherein entities in the topic facet are topic entities, wherein facets in the plurality of facets other than the topic facet are keyword facets; generating a visualization comprising the topic entities rendered as nodes arranged within a central region; and generating one or more surrounding shapes around the central region, wherein each of the surrounding shapes corresponds to one of the keyword facets, wherein entities within the corresponding keyword facet of a given one of the surrounding shapes are rendered as keyword entities.

The nodes in the central region are optionally clustered into topic clusters. The keyword entities for each topic cluster can be grouped in the corresponding surrounding shape into keyword clusters. A size of a given group of the keyword entities optionally corresponds to a size of a corresponding topic cluster. A correspondence between a given group of the keyword entities and the corresponding topic cluster is rendered in the surrounding shape, for example, using color and/or hash coding. The keyword clusters are optionally positioned to reduce line crossings and to be aligned with a corresponding topic cluster.

In one exemplary embodiment, the keyword entities are rendered in the one or more surrounding shapes as tag clouds. Topic entities can be rendered in the central region as clustered tag clouds.

The relations comprise internal relations that are connections between entities within a same facet and/or external relations that are connections between entities of different facets. Internal relations in the topic facet are optionally encoded using distance between primary entities. External relations are optionally encoded as lines connecting each primary entity with related keyword entities in the surrounding shape. Each line can be coded based on a cluster of the topic entity. A thickness of a given line optionally represents a number of topic entities related to a same keyword entity. The lines that are rendered at a given time may be controlled by a user. In addition, the selection of one of the facets as the topic facet may also be obtained from a user.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary data transformation process and an exemplary multi-facet entity-relational data model;

FIG. 2 illustrates an exemplary visual encoding of the exemplary data from FIG. 1 that incorporates features of the present invention;

FIG. 3 is a flow chart describing an exemplary implementation of a layout algorithm incorporating features of the present invention;

FIGS. 4A through 4C illustrate the cluster center detection, keyword wedge reordering and optimized cluster alignment portions of the layout process of FIG. 3 in further detail; and

FIG. 5 depicts a computer system that may be useful in implementing one or more aspects and/or elements of the present invention.

### DETAILED DESCRIPTION OF PREFERRED EMBODIMENTS

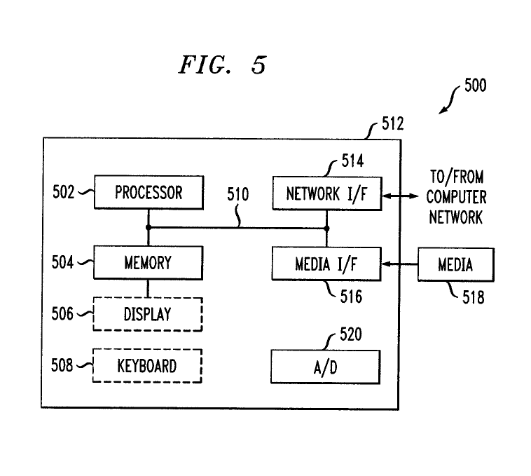

The present invention provides a multi-faceted visualization tool 500 (discussed further below in conjunction with FIG. 5) for visually exploring topics in multi-relational data. According to one aspect of the invention, a multifaceted visualization tool is provided that simultaneously visualizes the topic distribution of the underlying entities from one facet together with keyword distributions that convey the semantic definition of each cluster along a secondary facet.

The exemplary disclosed multifaceted visualization tool combines a labeled contour-based cluster visualization with a novel radially-oriented tag cloud technique. Conventionally, tag clouds display a set of words arranged in rows with font sizes that correspond to statistics such as term frequency. The exemplary disclosed multifaceted visualization tool enables multi-relational visualization of document collections at both the cluster and individual document scales. A cluster-aligned multifaceted radial tag-cloud technique is disclosed that employs a novel tag-cloud display of multifaceted textual metadata that is arranged radially around an interior cluster-based context preserving rendering of the dataset. Color coding and optimized radial alignment can be used to tie tags to corresponding clusters without the need for visually distracting edges. Multifaceted information can be laid out on to different radial rings of which one can be shown at any given time.

An exemplary embodiment also provides a rich set of interaction tools coordinated across visual elements of the visualization to enable detailed analysis at document and cluster scale. Dynamic highlighting and edges can be used to selectively pinpoint relationships as users interact with visual objects. Controls are also provided for users to switch between radial tag rings to focus on facets of interest during the analysis of multidimensional datasets.

A number of systems have been proposed for targeting multifaceted text corpora. These designs combine multiple visual techniques to depict information about both document content and inter-document relationships. For example, ContexTour uses a multi-layer tag cloud design that combines clusters with their layered tag clouds which use one layer to represent the content of a cluster for each facet. However, this “content-focused” design users does not convey any information about individual documents/entities or their individual relationships. See, for example, Y.-R. Lin et al., “ContexTour: Contextual Contour Visual Analysis on Dynamic Multi-Relational Clustering,” SIAM Data Mining Conf., 2010, incorporated by reference herein. In contrast, FacetAtlas provides a query based interface that focuses specifically on visualizing complex multifacet relationships. See, for example, N. Cao et al., “FacetAtlas: Multifaceted Visualization for Rich Text Corpora,” IEEE Trans. on Visualization and Computer Graphics 16, 1172-1181, 2010, incorporated by reference herein. The exemplary disclosed multifaceted visualization tool can be implemented, in part, for example, using aspects of both ContexTour and FacetAtlas within a single integrated visualization technique.

Data Model and Transformation

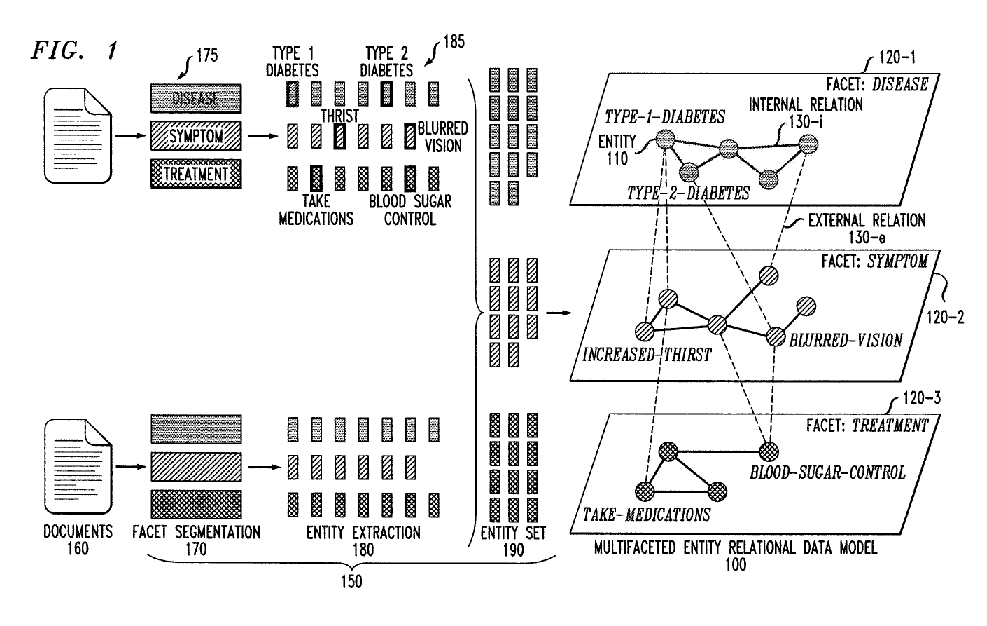

Documents are typically unstructured in nature. Visualizing the content of a document corpus and the relationships between documents requires that these unstructured artifacts be transformed into a structured form. The exemplary disclosed multifaceted visualization tool uses a multifaceted entity relational data model to represent this information in a structured way. FIG. 1 illustrates an exemplary data transformation process 150 and an exemplary multi-facet entity-relational data model 100. Generally, the data model 100 is a multi-faceted representation that captures entities and their relationships. As shown in FIG. 1, and discussed hereinafter, concepts in a complex text corpus are transformed into entities 110, facets 120 and relations 130. The facets 120, entities 110, and relations 130 are the abstract elements in the data model 100. For a more detailed discussion of an exemplary multi-facet entity-relational data model 100, see U.S. patent application Ser. No. 12/872,794, entitled “Multi-Faceted Visualizing of Rich Text Corpora,” assigned to the assignee of the present invention and incorporated by reference herein.

Generally, the exemplary data transformation process 150 transforms a set of raw unstructured documents 160 into the data model 100. The first stage of the exemplary data transformation process 150 is a facet segmentation stage 170. During this facet segmentation stage 170, each document 160 is segmented into facet snippets 175. While various techniques could be used, an exemplary embodiment employs a topic modeling technique such as LDA (see, for example, D. Blei et al., “Latent Dirichlet Allocation,” J. of Machine Learning Research, 3, 993-1022 (2003)) and treats each topic as a facet. When processing documents with a well defined structure (e.g., online Google Health documents which have standard sections for symptoms, treatments, etc.), the sections can be directly used to define facet snippets 175.

The second stage of the exemplary data transformation process 150 is an entity extraction stage 180. In the entity extraction stage 180, a named entity recognition algorithm 185 is applied to each facet's document snippet 175 to generate a set of typed entities 190. Domain-specific ontology models can be used to recognize meaningful entities for each facet. For example, in Google Health documents, entities in the symptom facet 120-2 could include “increased thirst” or “blurred vision”, while “type 1 diabetes” and “type 2 diabetes” are entities in the disease facet 120-1.

The third and final stage of the exemplary data transformation process 150 is a relation building stage. In this stage, connections between extracted entities are established using two types of relations: internal relations 130-i and the external relations 130-e. An internal relation 130-I connects entities within the same facet 120. For example, the entities “type-1-diabetes” and “type-2-diabetes” are connected within the disease facet 120-1 by an internal relation 130-i. An external relation 130-e is a connection between entities 110 from different facets 120. For example the disease “type-2-diabetes” is connected to the symptom “increased thirst” by an external relation 130-e because “increased thirst” is a symptom of “type-2-diabetes”. Finally, clusters are groups of similar entities 110 within a single facet 120. For example, a group of diseases related to “Type-1-Diabetes” forms a cluster on the disease facet 120-1.

Design Principles and Visual Encoding

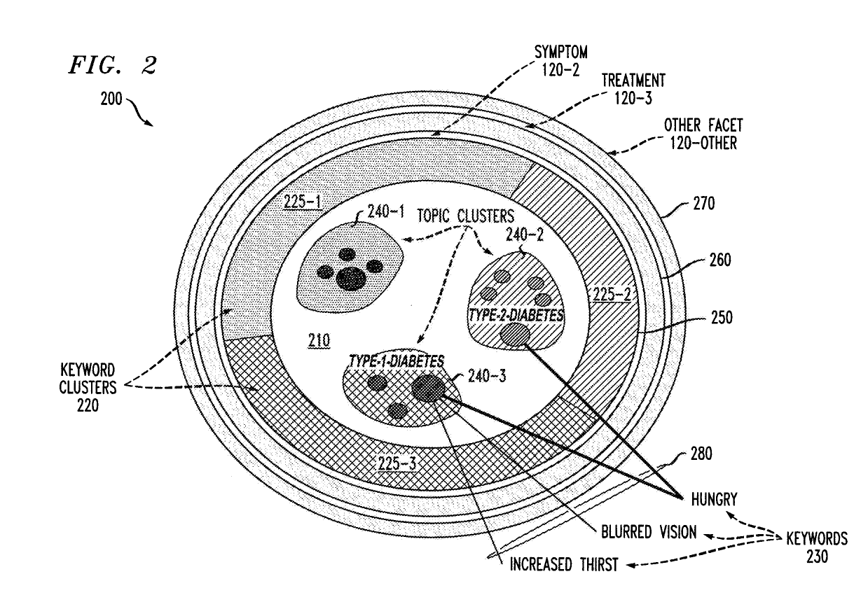

FIG. 2 illustrates an exemplary visual encoding 200 of the exemplary data from FIG. 1 that incorporates features of the present invention. The exemplary visual encoding 200 that is used to represent the information in the exemplary multi-facet entity-relational data model 100 is motivated by several design principles.

Focus and Context. In the exemplary disclosed multi-faceted visualization tool 500, there is one facet 120 selected at any given time to serve as the topic facet 120-T. Entities 110 in the topic facet 120-T (referred to collectively as topic entities 110-T) are considered in focus and are rendered as nodes arranged within the central region 210 of the visualization 200. The topic entities 110-T are clustered into topic clusters 240-1, 240-2, 240-3 by their internal relations 120-i to determine the spatial positions of the nodes. Contours are then rendered to further highlight the structures of the clusters 240. The value of each topic entity 110-T can be rendered on top of the node, resulting in a clustered tag cloud of labels for topic entities 110-T.

All other facets 120 other than the topic facet 120-T in the data model 100 are considered keyword facets 120-K, such as symptom facet 120-2 and treatment facet 120-3. Keyword facets are visually encoded as surrounding rings 250, 260, 270 that circle around the central topic cluster region 210. Entities 110 within a keyword facet 120-K are called keyword entities 110-K. In the exemplary disclosed multi-faceted visualization tool 500, only keyword entities 110-K from a single selected keyword facet 120-K are rendered at any given time. Keyword entities 110-K are displayed as radial tag clouds 230 and provide secondary contextual information about each cluster 240. The radial tag clouds 230 can be implemented, for example, using TextArc. See, for example, www.textarc.org.

Keyword entities 110-K for each cluster 240 are grouped into keyword clusters 220. The radial tags 230 are grouped into keyword clusters 220 based on the clusters 240 identified along the primary topic facet 120-T. This forms wedge-shaped sections 225-1, 225-2, 225-3 along each ring 250, 260, 270 with one wedge 225-1, 225-2, 225-3 for each cluster 240-1, 240-2, 240-3. The size of each wedge 225-1, 225-2, 225-3 in the exemplary embodiment indicates the size of the corresponding topic cluster 240-1, 240-2, 240-3, and the correspondence between cluster 240 and wedge 225 can be captured using, for example, both color (or hashing) and position.

For example, in FIG. 2, disease is selected as the topic facet 120-T with “Type-1-Diabetes” being one topic entity 110-T. Symptoms and treatments are both keyword facets 120-2, 120-3. In this example, Symptoms is the selected keyword facet 120-K resulting in keyword entities 110-K such as “blurred vision” and “increased thirst” being visualized along the corresponding ring 250. These entities appear in a wedge 225-3 of the symptom ring 250 because they are common symptoms for diseases in the corresponding cluster 240-3 found in the center 210 of the exemplary visual encoding 200. Content and Relations. The exemplary disclosed multi-faceted visualization tool 500 provides a unified visualization of both content entities 110 and the relationships 130 between them. As mentioned above, topic entities 110-T and keyword entities 110-K can be rendered as clustered tag clouds 240 and radial tag clouds 230, respectively. Internal relations 120-i in the topic facet 120-T can be encoded by screen distance between primary entities. External relations 120-e can be encoded as lines, such as lines 280, that connect each primary entity 110 with related keyword entities 230 in the selected facet ring 250.

Each line 280 is optionally coded (such as colored or dashed) by the cluster 240 of the topic entity 110-T and the thickness of a given line 280 can represent the number of topic entities 110-T related to the same keyword entity 230.

Rich Interaction. The exemplary disclosed multi-faceted visualization tool 500 includes a number of interactive features to enable rich data exploration. In addition to traditional tools like dynamic query and filtering, additional interactions are optionally supported. For example, a context switch capability of the exemplary disclosed multi-faceted visualization tool 500 allows users to change both the topic facet 120-T in the center ring 210 and the surrounding keyword facets 120-K in outer rings 250, 260, 270. Users can change the facet 120 assigned to be the topic facet 120-T, for example, by double clicking on any keyword facet ring 250, 260, 270. Users can optionally change the selected keyword facet 120-K by single-clicking on a facet ring 250, 260, 270. Another optional interactive feature provided by the exemplary disclosed multi-faceted visualization tool 500 is referred to as relation highlighting. By default, the lines 280 representing relations are not rendered to limit visual complexity. Moving a mouse or another user interface device over any entity 110 selectively displays the lines 280 representing its external relations 120-e. The textual tags for connected entities are also highlighted. Multiple selection, via mouse clicks, is also possible to highlight relations across multiple entities simultaneously. This technique is very effective at supporting entity comparison across various keyword facets 120-K.

Layout

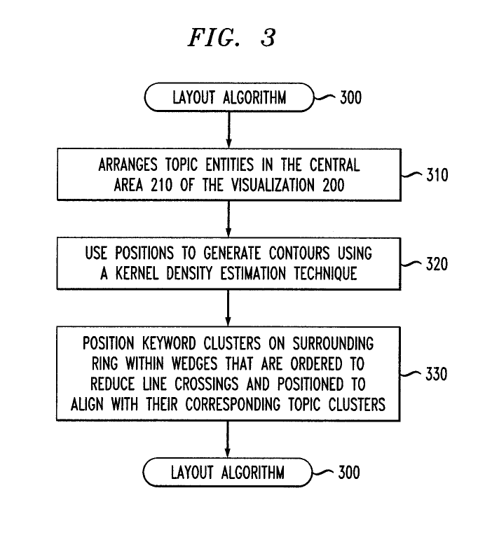

FIG. 3 is a flow chart describing an exemplary implementation of a layout algorithm 300 incorporating features of the present invention. As shown in FIG. 3, the exemplary layout algorithm 300 initially arranges topic entities 110-T in the central area 210 of the visualization 200 during step 310 using a stabilized graph layout algorithm. The positions are then used during step 320 to generate contours using a kernel density estimation technique. Finally, keyword clusters 220 are positioned during step 330 on the surrounding ring within wedges 225 that are ordered to reduce line crossings and positioned align with their corresponding topic clusters 240.

1. Topic Cluster Layout

The set of topic entities 110-T are connected via internal relations 120-i to form a graph as illustrated in FIG. 1. During topic cluster layout of steps 310 and 320, a stabilized graph layout algorithm (See, e.g., N. Cao et al., “Interactive Poster: Context-Preserving Dynamic Graph Visualization,” IEEE Symp. on Information Visualization (2008)) is applied to this graph. The stabilized graph layout algorithm minimizes the following energy metric:

$$min ( {\sum }_{i < j} \frac{1}{{d}_{ij}^{2}} {( ‖ {x}_{i} - {x}_{j} ‖ - {d}_{ij} )}^{2} + {\sum }_{i < j} {‖ {x}_{i} - {x}_{i}^{′} ‖}^{2} ) \qquad ( 1 )$$

The first term in equation (1) places pairs of strongly connected entities next to each other by minimizing the difference between screen layout distance (∥ₓᵢ-ₓⱼ∥) and graph distance (dᵢⱼ). The second part of the equation is a smoothness term that minimizes the change in distance between a position of an entity at sequential time-steps during animation.

After laying out the entities, contours are rendered to highlight clusters using, e.g., kernel density estimation (see, e.g., B. Turlach, “Bandwidth Selection in Kernel Density Estimation: A Review,” CORE and Institut de Statistique 23-493 (1993)). Generally, this algorithm places a Gaussian kernel over each entity and uses the joint distribution ƒ(x, y) of these kernels as the approximated information density. The bandwidth of each kernel is adjusted to get distribution with a high degree of smoothness. Finally, contour lines are generated using a contour plotting algorithm (see, e.g., C. Singh and D. Sarkar, “A Simple and Fast Algorithm for the Plotting of Contours Using Quadrilateral Meshes,” Finite Elements in Analysis and Design 7, 3, 217-228 (1990)). The details of this approach are described in N. Cao et al., “FacetAtlas: Multi-Faceted Visualization for Rich Text Corpora,” IEEE Trans. on Visualization and Computer Graphics 16, 1172-1181 (2010); or U.S. patent application Ser. No. 12/872,794, entitled “Multi-Faceted Visualizing of Rich Text Corpora,” each incorporated by reference herein.

2. Keyword Cluster Layout

After the topic clusters are positioned during steps 310 and 320, step 330 positions the color-coded (or hash-coded) keyword wedges 225-1, 225-2, 225-3 on the surrounding facet ring 250 next to their corresponding topic clusters 240-1, 240-2, 240-3. The wedges 225-1, 225-2, 225-3 within the ring 250 are first reordered based on the centroid of each topic cluster 240, as discussed in the following subsections. This reduces crossing of lines 280 when external relations 120-e are displayed. Then, a force based optimization model is used to rotate the ring 250 such that the distances between the wedges 225-1, 225-2, 225-3 and their related topic clusters 240-1, 240-2, 240-3 is minimized.

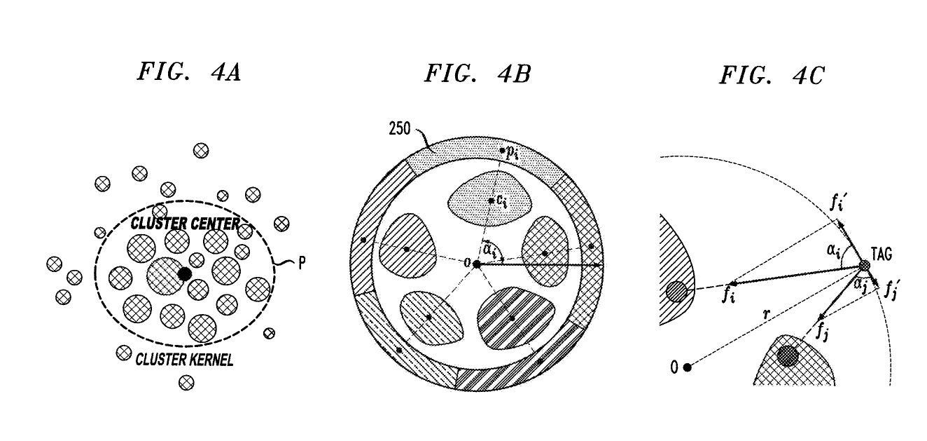

Cluster Center Detection. FIG. 4A illustrates the cluster center detection portion of the layout process 300. Center detection for each topic facet cluster Cᵢ begins by first extracting its kernel set C′ᵢ. Using the kernel set, any outlier entities that are far away from other cluster members are detected and removed. Then, the convex hull P of C′ᵢ is computed and used as cluster boundary. Finally, as shown in FIG. 4A, a center of mass (Cluster Center) is computed by considering the joint kernel density distribution ƒ(x, y) within the boundary P using the following formula:

$${c}_{x} = \frac{\int xf ( x , y ) d x}{\int f ( x , y ) d x} , {c}_{y} = \frac{\int yf ( x , y ) d y}{\int f ( x , y ) d y} \qquad ( 2 )$$

To accelerate the layout process, the density distribution is treated as a constant. This approach reduces the above formulas to the following:

$${c}_{x} = \frac{1}{6 A} {\sum }_{i = o}^{n - 1} ( {x}_{i} + {x}_{i} + 1 ) ( {x}_{i} {y}_{i} + 1 - {x}_{i} + 1 {y}_{i} ) \\ {c}_{y} = \frac{1}{6 A} {\sum }_{i = o}^{n - 1} ( {y}_{i} + {y}_{i} + 1 ) ( {x}_{i} {y}_{i} + 1 - {x}_{i} + 1 {y}_{i} ) \qquad ( 3 )$$

where A is the area of P, (xᵢ, yᵢ) is the ith vertex of polygon P.

Keyword Wedge Ordering. To reduce line crossings and minimize the distances between keyword wedges 225 and their associated topic clusters 240, the wedges can be organized based on the angular position of the topic clusters 240 using a projection line technique. The center of each topic cluster's contour Cᵢ is projected out to the surrounding ring 250 by using a projection line that starts at the center of the visualization canvas. FIG. 4B illustrates the keyword wedge reordering portion of the layout process 300. The projection line for Cᵢ intersects the facet ring 250 at point pᵢ, as shown in FIG. 4B. The radial order of these positions are then used to order the keyword wedges.

Optimized Cluster Alignment. After ordering the wedges 225, the final step is optimized cluster alignment which rotates the keyword facet ring 250 to an angle that best aligns each wedge 225 with its corresponding topic cluster 240. FIG. 4C illustrates the optimized cluster alignment portion of the layout process 300. The alignment can be accomplished through the force-based optimization model defined below.

$$min {\sum }_{i} ( {f}_{i} \times r \times cos ( {a}_{i} ) ) \qquad ( 4 )$$

The model minimizes the sum of the computed forces for all external relations i between the topic entities 110-T and the displayed keyword entities 110-K. The force equation is based on the moment of force where ƒᵢ is a spring-force equation based on the distance between the pair of related entities, r is the radius of the ring, and αᵢ is the angle of the edge representing the relation. These terms are illustrated in FIG. 4C. This model will rotate the facet until the sum of the forces is minimized, resulting in a ring that is optimally aligned with the interior topic entities.

Among other benefits, the exemplary disclosed multi-faceted visualization tool 500 can explain relations between entities. For example, the exemplary disclosed multi-faceted visualization tool 500 can explain how two diseases are related to each other. For example, a user can double click on the diseases that he or she wishes to compare to select them. This optionally highlights the external relations 120-e for the selected diseases. By switching through different keyword facets 120-K (e.g., symptom, complication, and cause), it can be observed that Type-1-Diabetes and Type-2-Diabetes are related because they share similar symptoms such as “increased urination” and “fatigue”, as well as similar complications such as “kidney disease ” and “Stroke”. However, they do not share any common causes. In this manner, the exemplary disclosed multi-faceted visualization tool 500 can explain clusters through the links between topic clusters 240 and keyword clusters 220.

The exemplary disclosed multi-faceted visualization tool 500 can simultaneously visualize both underlying topic distribution and corresponding keyword topics. In particular, topic distribution is displayed through the use of a contour map and graph visualization; and keyword topics are displayed through the keyword rings. Moreover, the exemplary disclosed multi-faceted visualization tool 500 can be globally optimized such that 1) topic similarity is used in placing topic cluster on the contour map; and 2) keyword cluster on the ring is placed closer to its corresponding topic cluster through swapping and rotation.

Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. FIG. 5 depicts an exemplary multi-faceted visualization tool 500 that may be useful in implementing one or more aspects and/or elements of the present invention. With reference to FIG. 5, such an implementation might employ, for example, a processor 502, a memory 504, and an input/output interface formed, for example, by a display 506 and a keyboard 508. The memory 504 may store, for example, code for implementing the layout process 300 of FIG. 3.

The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like.

In addition, the phrase “input/output interface” as used herein, is intended to include, for example, one or more mechanisms for inputting data to the processing unit (for example, mouse), and one or more mechanisms for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Analog-to-digital converter(s) 520 may be provided to receive analog input, such as analog video feed, and to digitize same. Such converter(s) may be interconnected with system bus 510.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 518 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the FIGS. illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Method steps described herein may be tied, for example, to a general purpose computer programmed to carry out such steps, or to hardware for carrying out such steps, as described herein. Further, method steps described herein, including, for example, obtaining data streams and encoding the streams, may also be tied to physical sensors, such as cameras or microphones, from whence the data streams are obtained.

It should be noted that any of the methods described herein can include an additional step of providing a system comprising distinct software modules embodied on a computer readable storage medium. The method steps can then be carried out using the distinct software modules and/or sub-modules of the system, as described above, executing on one or more hardware processors 502. In some cases, specialized hardware may be employed to implement one or more of the functions described here. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for visualizing a data set, comprising:
obtaining said data set comprising a plurality of entities, facets and relations, wherein said entities are instances of a particular concept, said facets are classes of entities and said relations are connections between pairs of said entities;
obtaining a selection of one of said facets as a topic facet, wherein entities in said topic facet are topic entities, wherein facets in said plurality of facets other than said topic facet are keyword facets;
generating a visualization comprising said topic entities rendered as nodes arranged within a central region; and
generating one or more surrounding shapes around said central region, wherein each of said surrounding shapes corresponds to one of said keyword facets, wherein entities within said corresponding keyword facet of a given one of said surrounding shapes are rendered as keyword entities.

2. The method of claim 1, wherein said one or more surrounding shapes comprise a plurality of concentric surrounding shapes.

3. The method of claim 1, wherein said keyword entities are rendered in said one or more surrounding shapes as tag clouds.

4. The method of claim 1, wherein said nodes in said central region are clustered into topic clusters.

5. The method of claim 4, wherein said keyword entities for each topic cluster are grouped in said corresponding surrounding shape into keyword clusters.

6. The method of claim 5, wherein a size of a given group of said keyword entities corresponds to a size of a corresponding topic cluster.

7. The method of claim 5, wherein a correspondence between a given group of said keyword entities and said corresponding topic cluster is rendered in said surrounding shape.

8. The method of claim 7, wherein said correspondence between said given group of said keyword entities and said corresponding topic cluster is indicated by coding said given group of said keyword entities in said surrounding shape.

9. The method of claim 5, further comprising the step of positioning said keyword clusters to reduce line crossings and to be aligned with a corresponding topic cluster.

10. The method of claim 1, wherein said topic entities are rendered in said central region as clustered tag clouds.

11. The method of claim 1, wherein said relations comprise one or more internal relations that are connections between entities within a same facet and one or more external relations that are connections between entities of different facets.

12. The method of claim 11, wherein internal relations in said topic facet are encoded using distance between primary entities.

13. The method of claim 11, wherein external relations are encoded as lines connecting each primary entity with related keyword entities in said surrounding shape.

14. The method of claim 13, wherein each line is coded based on a cluster of said topic entity.

15. The method of claim 13, wherein a thickness of a given line represents a number of topic entities related to a same keyword entity.

16. The method of claim 13, wherein said lines that are rendered at a given time are controlled by a user.

17. The method of claim 1, wherein said selection of one of said facets as said topic facet is obtained from a user.

18. The method of claim 1, wherein said topic entities are rendered as nodes in said central region using a stabilized graph layout algorithm.

19. An apparatus for visualizing a data set, said apparatus comprising:
a memory; and
at least one processor, coupled to the memory, operative to:
obtain said data set comprising a plurality of entities, facets and relations, wherein said entities are instances of a particular concept, said facets are classes of entities and said relations are connections between pairs of said entities;
obtain a selection of one of said facets as a topic facet, wherein entities in said topic facet are topic entities, wherein facets in said plurality of facets other than said topic facet are keyword facets;
generate a visualization comprising said topic entities rendered as nodes arranged within a central region; and
generate one or more surrounding shapes around said central region, wherein each of said surrounding shapes corresponds to one of said keyword facets, wherein entities within said corresponding keyword facet of a given one of said surrounding shapes are rendered as keyword entities.

20. An article of manufacture for visualizing a data set, comprising a tangible machine readable storage medium containing one or more programs which when executed implement the step of:
obtaining said data set comprising a plurality of entities, facets and relations, wherein said entities are instances of a particular concept, said facets are classes of entities and said relations are connections between pairs of said entities;
obtaining a selection of one of said facets as a topic facet, wherein entities in said topic facet are topic entities, wherein facets in said plurality of facets other than said topic facet are keyword facets;
generating a visualization comprising said topic entities rendered as nodes arranged within a central region; and
generating one or more surrounding shapes around said central region, wherein each of said surrounding shapes corresponds to one of said keyword facets, wherein entities within said corresponding keyword facet of a given one of said surrounding shapes are rendered as keyword entities.

21. The article of manufacture of claim 20, wherein said keyword entities are rendered in said one or more surrounding shapes as radial tag clouds and wherein said topic entities are rendered in said central region as clustered tag clouds.

22. The article of manufacture of claim 20, wherein said nodes in said central region are clustered into topic clusters.

23. The article of manufacture of claim 22, wherein said keyword entities for each topic cluster are grouped in said corresponding surrounding shape into keyword clusters.

24. The article of manufacture of claim 20, wherein said one or more surrounding shapes comprise a plurality of concentric surrounding shapes.

25. The article of manufacture of claim 20, wherein said nodes in said central region are clustered into topic clusters.
